(19) United States
(12) Patent Application Publication
(10) Pub. No.: US 2015/0355111 A1
(43) Pub. Date: Dec. 10, 2015

(54) TRACERS FOR USE IN COMPRESSION MOLDING OF UNIDIRECTIONAL DISCONTINUOUS FIBER COMPOSITE MOLDING COMPOUND

(71) Applicant: HEXCEL CORPORATION, Dublin, CA (US)

(72) Inventor: Bruno Boursier, Dublin, CA (US)

(73) Assignee: HEXCEL CORPORATION, Dublin, CA (US)

(21) Appl. No.: 14/300,034

(22) Filed: Jun. 9, 2014

(51) Int. Cl. G01N 23/04; B32B 5/08; B32B 5/12

(52) U.S. Cl. CPC G01N 23/04; B32B 5/12; B32B 5/08; B32B 2262/106; B32B 2262/101; B32B 2307/40

(57) ABSTRACT

Tracking or tracing of both the global and local movements of unidirectional discontinuous fiber composite (UD-DFC) chips during compression molding of UD-DFC molding compound. The tracking capability is provided by including tracer chips in the UD-DFC molding compound. The tracer chips include a resin matrix and at least one unidirectional carbon tow which is made up of a plurality of carbon filaments. The tracer chip further includes a unidirectional tracer yarn which is made up of a plurality of unidirectional filaments that are detectable by x-ray or other radiation-based scanning technique.

### BACKGROUND OF THE INVENTION

1. Field of the Invention

The present invention relates generally to compression molding of discontinuous fiber composite (DFC) material. More particularly, the present invention is directed to tracking or tracing the movement of the fibrous chips in unidirectional discontinuous fiber composite (UD-DFC) molding compound that occurs during compression molding of complex objects at high molding pressures.

2. Description of Related Art

Fiber-reinforced composite structures typically include a resin matrix and fibers as the two principal components. These structures are well-suited for use in demanding environments, such as in the field of aerospace, where a combination of high strength and light weight is important.

Pre-impregnated composite material (prepreg) is used widely in the manufacture of composite parts and structures. Prepreg is a combination of uncured resin matrix and fiber reinforcement that is ready for molding and curing into the final composite part. By pre-impregnating the fiber reinforcement with resin, the manufacturer can carefully control the amount and location of resin that is impregnated into the fiber network and ensure that the resin is distributed in the network as desired. Prepreg is a preferred material for use in manufacturing load-bearing structural parts and particularly load-bearing aircraft parts that are used in wings, fuselages, bulkheads and control surfaces. It is important that these parts have sufficient strength, damage tolerance and other requirements that are routinely established for such parts.

Unidirectional (UD) tape is a common form of prepreg. The fibers in unidirectional tape are continuous fibers that extend parallel to each other. The fibers are typically in the form of bundles of numerous individual fibers or filaments that are referred to as a “tows”. The unidirectional fibers are impregnated with a carefully controlled amount of uncured resin. The UD prepreg is typically placed between protective layers to form the UD final tape that is rolled up for storage or transport to the manufacturing facility. The width of UD tape typically ranges from less than one inch to a foot or more.

Unidirectional tape is not well-suited for use as a molding compound for forming complex three dimensional structures using compression molding techniques. The parallel orientation and continuous nature of the fibers in the UD tape cause fiber bunching or bridging when the UD tape is forced to fit the features of the complex part. As a result, the manufacture of complex three dimensional parts using UD tape has been limited to a laborious process where individual plies of UD tape are applied directly to a three dimensional mold, which is subsequently processed in an autoclave or other molding apparatus. This lay-up procedure using UD tape tends to be a long and costly process.

Molding compounds, which are generically referred to as discontinuous fiber composite (DFC) molding compound, have been found to be suitable for compression molding complex parts. One type of DFC molding compound is composed of random segments of individual fibers that are combined with a resin matrix. The randomly oriented chopped fibers more easily fit the features of the part. However, the movement of the random short fibers during high-pressure molding can vary unpredictably from one molded part to the next and may also differ between different features of a given part.

Another type of DFC molding compound, which is referred to herein as unidirectional discontinuous fiber composite (UD-DFC), combines the attributes of UD tape and randomly oriented short fibers into a single molding compound that can be accurately molded and machined to form a wide variety of relatively complex structures. UD-DFC molding compound is composed of randomly oriented segments or chips of unidirectional tape that have been impregnated with thermosetting resin. This type of quasi-isotropic unidirectional discontinuous fiber molding compound has been used to make molds and a variety of aerospace components. The UD-DFC molding compound is available from Hexcel Corporation (Dublin, Calif.) under the trade name HexMC®. Examples of the types of parts that have been made using HexMC® are described in U.S. Pat. Nos. 7,510,390; 7,960,674 and published US Patent Application US2012-0040169-A1, the contents of which are hereby incorporated by reference.

UD-DFC molding compound is typically made by laying multifilamentary tows (yarns) parallel to each other on a suitable backing and impregnating the parallel tows with resin to form a UD prepreg. The UD prepreg is then chopped to form UD chips which are generally from 5 mm to 25 mm wide and from 25 mm to 125 mm long. A layer of quasi-isotropically oriented UD chips is then formed. Multiple layers of the quasi-isotropically oriented UD chips are combined together to form a ply-like molding material which is referred to herein as unidirectional discontinuous fiber composite (UD-DFC) molding compound or material.

There is some movement of the randomly oriented chips globally during molding of UD-DFC, especially at higher molding pressures. The parallel tows that make up the individual chips may also be distorted locally within each chip so that the initial parallel orientation of the tows may be disturbed. In addition, the filaments that make up the tows may also be distorted locally within each tow.

The global and local distortion or deformation of the UD-DFC chips can have a significant effect on the mechanical properties of the resulting molded part. For structural applications, the part designer must understand and account for the effect that such distortion has during molding. The material and process engineer is tasked with attempting to reduce global and local distortion of the UD-DFC chips. In either case, it would be desirable to provide a way to track or trace both the global and local movement of the UD-DFC chips, tows and filaments during the molding process.

### SUMMARY OF THE INVENTION

In accordance with the present invention, a method is provided for tracking or tracing both the global and local movements of UD-DFC chips during molding of UD-DFC molding compound. This tracking capability is provided by including tracer chips in the UD-DFC molding compound. The tracer chips include a resin matrix and at least one unidirectional carbon tow which is made up of a plurality of carbon filaments. The tracer chip further includes a unidirectional tracer yarn or tow which is made up of a plurality of unidirectional filaments that are detectable by x-ray or other radiation-based scanning techniques and related imaging systems.

It was discovered that substituting a tracer yarn composed of non-carbon filaments in place on one carbon tow per UD-DFC chip provides an effective way to track both global and local movement of the UD-DFC chips during molding. The small proportion of tracer yarn that is required to provide tracking is not sufficient to adversely affect the mechanical properties of the molded part.

The invention is directed not only to the tracer chips, but also to UD-DFC molding compound that includes the tracer chips. The tracer chips can be uniformly distributed throughout the UD-DFC molding compound or the tracer chips can be localized in different areas to provide zone-specific tracking of the chip movement.

The tracer chips are particularly useful for tracking the global and local movement of UD-DFC chips at the joint between two pieces of UD-DFC molding compound during molding. The invention is particularly well-suited for revealing potential weak joints, which are commonly referred to a “knit-lines”. Knit-lines occur when two pieces of molding material meet each other without sufficient intermingling during high pressure molding. Locating tracer chips at the joint provides for global and local tracing of chip movement at the joint. Such tracing is important to monitor chip movement and fiber intermingling to determine if an undesirable knit-line has been formed at the joint. As a feature of the invention, molding of the two UF-DFC pieces is first carried out with tracer chips located in only one of the pieces. A second molding operation is then carried out with tracer chips located in the other piece of UD-DFC. The X-ray images of the two moldings are then overlaid to provide a combined image of the joint which is particularly useful in detecting the presence of a knit-line. It was discovered that conducting a single molding operation in which both UD-DFC pieces contained tracer chips at the joint resulted in a single X-ray image that was not as effective in revealing knit-lines.

The present invention is also directed to methods for monitoring the movement of UD-DFC molding compound during high-pressure molding. The method involves monitoring the movement of the tracer chips which may be located in a wide variety of orientations in the UD-DFC molding compound depending upon the configuration of the preform and the size of the part. Monitoring is typically accomplished by measuring the position of the tracer chips both before and/or after molding. The method is applicable to monitoring joints and knit-lines in the part made of UD-DFC. The method may also be used to monitor global and local chip movement and deformation in overlapped plies or drop-offs, as well as geometric section changes and curves in the mold and other complex shapes. The method may also be used as a quality control tool to measure or observe the tracer chips after the preform has been formed and/or after the part has been molded to ensure that the desired positioning and orientation of the UD-DFC chips has been achieved.

The above described and many other features and attendant advantages of the present invention will become better understood by reference to the following detailed description when taken in conjunction with the accompanying drawings.

### BRIEF DESCRIPTION OF THE DRAWINGS

FIG. 1 is a top simplified view of an exemplary tracer chip in accordance with the present invention.

FIG. 2 is a simplified side view of the tracer chip shown in FIG. 1.

FIG. 3 is a simplified view of a sheet of UD-DFC molding compound which includes tracer chips in accordance with the present invention.

FIG. 4 is a simplified side view of a UD-DFC molding compound that is made up of 8 sheets of UD-DFC material shown in FIG. 3.

FIG. 5 shows an exemplary sheet of tracer chip-containing UD-DFC molding compound prior to being shaped into a perform for molding.

FIG. 6 shows the DFC preform which is formed from the sheet of UD-DFC molding compound shown in FIG. 5.

FIG. 7 shows the molded part that results from compression molding of the UD-DFC preform shown in FIG. 6.

FIG. 8 is an X-ray image of the molded part shown in FIG. 7 which shows the observed location and orientation of the glass fiber tracer tow.

FIG. 9 is an X-ray image of a 4-layer UD-DFC laminate before molding (A) and after molding (B) wherein the tracer chips are located in the top layer, which is a drop off layer.

FIG. 10 is an X-ray image of a 5-layer UD-DFC laminate before molding (A) and after molding (B) wherein the tracer chips are located in a drop off layer which is in the middle layer of the laminate.

FIG. 11 is an X-ray image of a 4-layer UD-DFC laminate before molding (A) and after molding (B) wherein the tracer chips are located in a full layer which is located below a drop off layer in the laminate.

FIG. 12 is an X-ray image of a 5-layer UD-DFC laminate before molding (A) and after molding (B) wherein the tracer chips are located in full layer that is the top layer of the laminate.

FIG. 13 is an X-ray image of a 5-layer UD-DFC laminate before molding (A) and after molding (B) wherein the tracer chips are located in a full layer that is located in the middle of the laminate.

FIG. 14 is an X-ray image of a 5-layer UD-DFC laminate before molding (A) and after molding (B) wherein the tracer chips are located in a partial layer that is located on top of another partial layer to form a 5 cm overlap on the top of the laminate.

FIG. 15 is an X-ray image of a 6-layer UD-DFC laminate before molding (A) and after molding (B) wherein the tracer chips are located in a partial layer that is located on top of another partial layer in the middle of the laminate to form a 5 cm overlap in the middle of the laminate.

FIG. 16 shows side-view X-ray images of a composite part made by compression molding two pieces of molding compound together where image (A) shows the X-ray image when only the top piece of molding compound contains tracer chips and where image (B) shows the X-ray image when only the bottom piece of molding compound contains tracer chips.

FIG. 17 shows side-view X-ray images of a composite part that is the same as the composite part shown in FIG. 16, except that the composite part is made by compression molding two different pieces of molding compound together where image (A) shows the X-ray image when only the top piece of molding compound contains tracer chips and where image (B) shows the X-ray image when only the bottom piece of molding compound contains tracer chips.

### DETAILED DESCRIPTION OF THE INVENTION

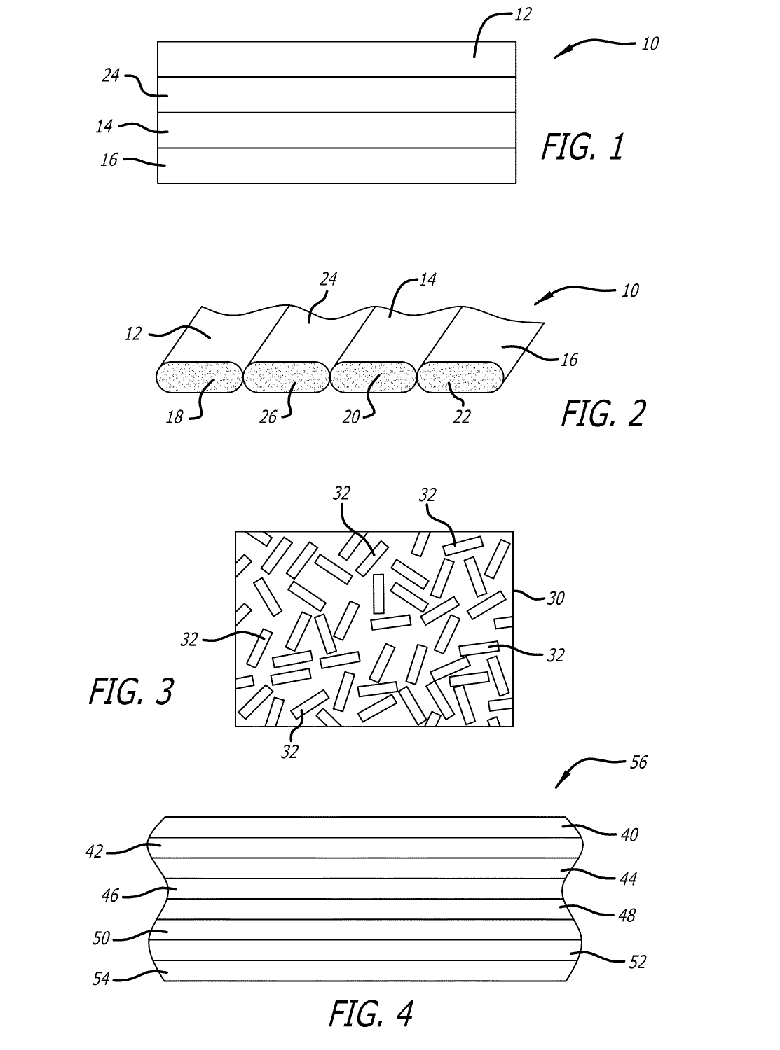

An exemplary tracer chip in accordance with the present invention is shown at 10 in FIGS. 1 and 2. The tracer chip 10 includes unidirectional (UD) tows 12, 14 and 16. Each tow is made up of a plurality of unidirectional filaments represented at 18, 20 and 22. Although other types of filaments may be used, it is preferred that the UD tows are carbon fiber tows that are composed of carbon filaments.

Carbon fiber tows are widely used in UD-DFC molding compound. The carbon fiber tows generally contain from 1,000 to 50,000 individual carbon filaments. Commercially available carbon tows contain, for example, approximately 3000 filaments (3K), 6000 filaments (6K), 12000 (12K) filaments or 24000 (24K) filaments. A single carbon filament generally has a linear weight that ranges from 0.02 to 0.5 milligrams per meter.

The tracer chip 10 also includes a unidirectional tracer yarn 24. The tracer yarn 24 is made up of a plurality of unidirectional filaments 26 that are detectable by X-rays or other scanning/imaging radiation. The tracer yarn 24 is preferably a glass fiber yarn that includes a plurality of unidirectional glass filaments. The number of glass filaments in the tracer yarn may be varied from 1 to however many filaments are needed to achieve the desired X-ray image. The weight content of glass filaments in the tracer chip 10 should be kept low enough to preserve the mechanical and distortion properties of the tracer chip. Preferably, the weight content of the glass filaments in the tracer chip should range from 5% to 15% of the total weight of the tracer chip.

The cross-sectional size of the glass tracer yarn 24 should be equal to or preferably greater than the cross-sectional size of the UD carbon tows 12, 14 and 16. It was found that using glass yarns that have a larger cross-sectional size than the carbon filaments provides better contrast between X-ray images of the two fiber types. Carbon filaments are not detectable by X-rays or other related imaging systems, so the cross-sectional size of the carbon filaments is not particularly important. However, glass filaments are detectable by X-ray or other related imaging systems.

The total number of tracer yarns in each tracer chip can be varied. However, it is preferred that each tracer chip include only one tracer yarn in order to prevent excessive and redundant information from X-ray images.

The tracer chip 10 also includes a matrix resin. The resin matrix may be any of the resins typically used in UD-DFC material. The matrix resin is present in amounts ranging from 25 to 45 weight percent of the total weight of the tracer chip. Examples included epoxy resins, bismaleimide resins, polyimide resins, polyester resins, vinylester resins, cyanate ester resins, phenolic resins or thermoplastic resins that are used in structural composite materials. Exemplary thermoplastic resins include polyphenylene sulfide (PPS), polysulfone (PS), polyetheretherketone (PEEK), polyetherketoneketone (PEKK), polyethersulfone (PES), polyetherimide (PEI), polyamide-imide (PAI). Epoxy resins that are toughened with a thermoplastic, such as PES, PEI and/or PAI, are preferred resin matrices. Resins that are typically present in UD tape of the type used in the aerospace industry are preferred. Exemplary thermoplastic toughened resins that are suitable for use as the resin matrix are described in U.S. Pat. Nos. 7,754,322; 7,968,179; and 8,470,923, the contents of which are hereby incorporated by reference.

The tracer chip is made in the same manner as conventional UD-DFC chips with the only difference being that a yarn composed of X-ray detectable filaments is either substituted for one of the carbon tows in each chip or added to the carbon tows. It is possible to make the tracer chips by making a resin-impregnated UD tape that is composed of a single detectable tow and one or more parallel carbon tows. This relatively narrow (e.g. 2 mm to 12 mm wide) UD tape can then be chopped to form the tracer chips. However, the preferred method is to make a relatively wide resin-impregnated UD tape (e.g. 250 mm to 500 mm wide) in which detectable yarns are spaced apart (e.g. one detectable yarn every 8 mm to 12 mm) so that the wider tape can be cut in the direction parallel to the yarns to form individual tapes (e.g. 8 mm to 12 mm wide) which each contain a detectable yarn. The multiple individual tapes are then cut to form the tracer chips that include a single detectable yarn.

The number of filaments in the detectable yarn and the cross-sectional size and shape of the detectable filaments is chosen based on the type of carbon fiber tows in the tracer chip and the overall width of the tracer chip. For example, the following combinations of glass fiber tows and carbon tows are suitable for a tracer chip.

The size of the tracer chips should match the size of the other chips in the rest of the UD-DFC material. However, it may be desirable for certain applications to make the tracer chips either smaller or larger than the non-tracer chips in the UD-DFC material. Typically, the size of the tracer chips will be from 5 mm to 25 mm wide and from 25 nm to 125 mm long.

FIG. 3 depicts a layer of UD-DFC material 30 in which a single layer of coplanar quasi-isotropically oriented tracer chips are shown at 32. The tracer chips are intermixed with coplanar quasi-isotropically oriented UD-DFC chips (not shown) so that the UD-DFC material includes a combination of tracer chips 32 and regular UD-DFC chips. The amount of tracer chips that make up the UD-DFC layer 30 can range from 100% of the total number of chips in the UD-DFC layer down to 1% of the total number of chips depending upon the intended use for the layer 30.

A layer of UD-DFC material 30, which includes a single coplanar layer of tracer chips 32 combined with regular UD-DFC chips, is typically combined with other single layers of coplanar tracer and/or regular chips to form a multiple layered tracer sheet of UD-DFC molding compound that contains, for example, from 3 to 6 coplanar layers of chips. The multiple layered tracer sheet is then stacked with other multiple layered UD-DFC sheets, which may or may not contain a tracer sheet (UD-DFC material 30), to form UD-DFC molding compound 56 as shown in FIG. 4. The UD-DFC molding compound 56 is composed of a single multiple layered tracer sheet 46, which contains at least one tracer sheet 30, and seven multiple layered UD-DFC sheets 40, 42, 44, 48, 50 and 52, which contain regular (non-tracer) UD-DFC chips. The molding compound 56 is typically used alone or in combination with other sheets of molding compound to form a wide variety of preforms that can be compression molded to form a composite part.

The molding compound 56 is shown with only one of the UD-DFC sheets (46) being a multiple layered tracer sheet. In many situations, especially when the preform includes sections where the molding compound is overlapped, it may not be possible to obtain a useful X-ray image because there are too many tracer chips present in the section. In accordance with the invention, the number of tracer chips that end up in a particular section of the preform and molded part is controlled by: 1) varying the number of tracer chips 32 in the initial layer 30 of coplanar chips; 2) varying the number of initial layers 30 in the multiple layered UD-DFC sheets; and 3) varying the number of tracer chip-containing multiple layered UD-DFC sheets that are in the molding compound 56.

For most molding applications, it is preferred to start with an initial single layer 30 which contains from 50% to 100% tracer chips. The tracer chip layer 30 is then combined with 3 layers of single coplanar regular UD-DFC chips to form a multiple layered tracer sheet. The molding compound is then formed by combining the multiple layer tracer sheet with 7 multiple layered sheets, which each contains 4 layers of regular UD-DFC chips that are each a single chip thick. X-ray images are taken both before and after molding to determine if a suitable image can be obtained. If necessary, the number of tracer chips in the tracer chip layer 30 can increased or decreased to obtain a suitable X-ray image. In addition, the number of tracer chip layers can be increased or decreased in the multiple layer tracer sheet and/or the number of multiple layer tracer sheets in the molding compound can be increased or decreased in order to obtain a suitable X-ray image.

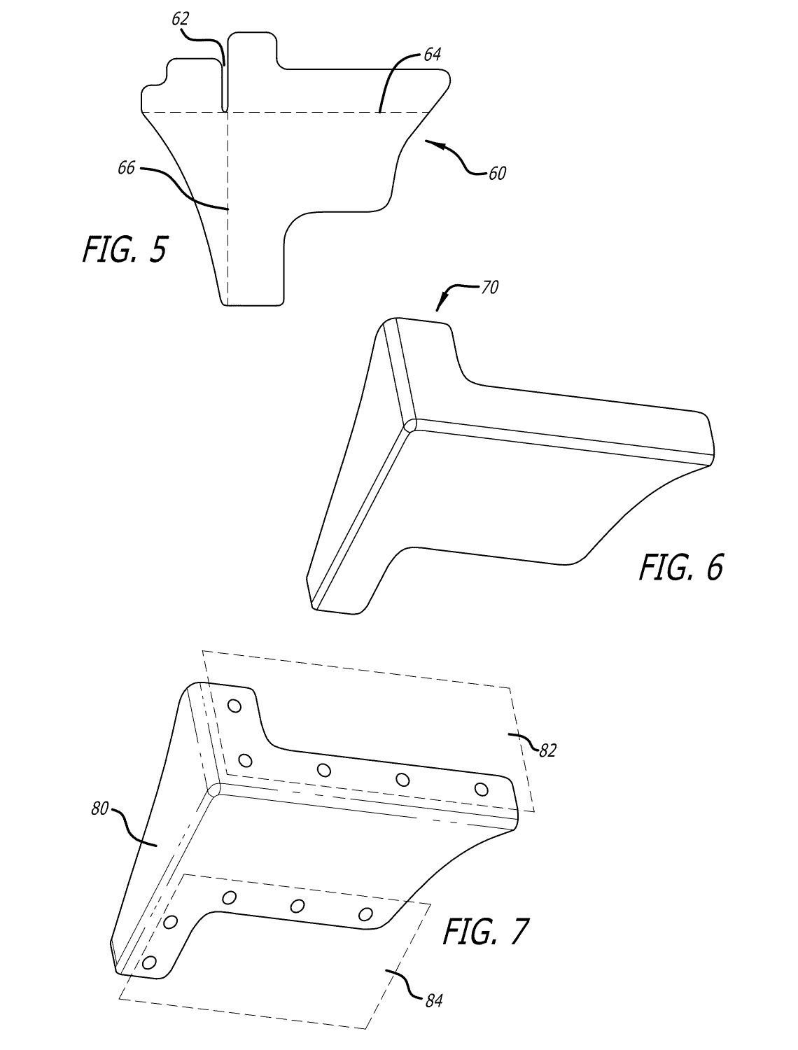

The molding compound 56 can be formed into any suitable preform shape which is then compression molded to form a composite part. As shown in FIG. 5, molding compound 56 has been cut into a preliminary preform or cut-out 60. The preliminary preform 60 includes a slot 62 that has been cut into the molding compound and fold lines 64 and 66. The preliminary preform 60 is folded along fold lines 64 and 66 so that the tab sections 68 and 69 overlap with the result being the formation of preform 70, which is shown in FIG. 6. More than one sheet of molding compound 56 may be used to form preliminary preforms 60 that include multiple layers of molding compound.

The preform 70 is cured using known compression molding procedures to produce the final part 80, as shown in FIG. 7. The molded part 80 is a clip that is designed to connect two primary structures of an aircraft together. The two primary structure aircraft parts 82 and 84 are shown in phantom. Clip 80 is an example of the type of complex UD-DFC aircraft part that can be made and monitored using tracer chips in accordance with the present invention.

Molding of the preform 70 is carried out according to known molding procedures for UD-DFC molding compounds. The preform 70 is placed in a mold that is typically composed of two mold halves and formed into the desired shape. Once set in the mold, which is pre-heated to the curing temperature of the resin, the preform is molded at high pressure to form the clip 80. Typical high-pressure curing temperatures for epoxy resins range from 120° C. to 225° C. Preferred curing temperatures range from 170° C. to 205° C. Internal pressures within the mold are preferably above 500 psi and below 2000 psi at the cure temperatures. Once the preform 70 has been completely cured (typically 3 minutes to 1 hour at curing temperature), the part is removed from the mold and cooled to form composite clip 80.

In accordance with the present invention, the tracer chips 32, which are located in layer 46 of the molding compound 56 that is used to form preform 70, are observed or imaged by X-ray imaging or other radiation-based scanning or imaging techniques, such as computerized tomography (CT) scanning. X-ray imaging according to known aerospace non-destructive testing procedures are preferred.

In order to monitor the movement of the UD-DFC chips during molding, it is preferred that the preform 70 is X-ray imaged to ascertain the initial global positioning of the tracer chips 32 and local positioning of the glass yarns and filaments. The molded clip 80 is X-ray imaged to determine the post-molding positioning of the tracer chips and glass filaments. The two X-ray images may be compared in order to determine the degree of global movement and local distortion of the tracer chips during the molding process.

The preceding monitoring process in which the pre-molding X-ray image is compared to the post-molding X-ray image is particularly useful in the initial design and optimization of a compression molding process for a particular part using a particular type of UD-DFC molding compound. The preforms 70 may also be routinely X-ray imaged during production runs in order to ensure that the tracer chips meet expected global and local positioning requirements. The same is true for routine X-ray imaging of the molded clips 80 to ensure that tracer chip movement has occurred in accordance with design expectations.

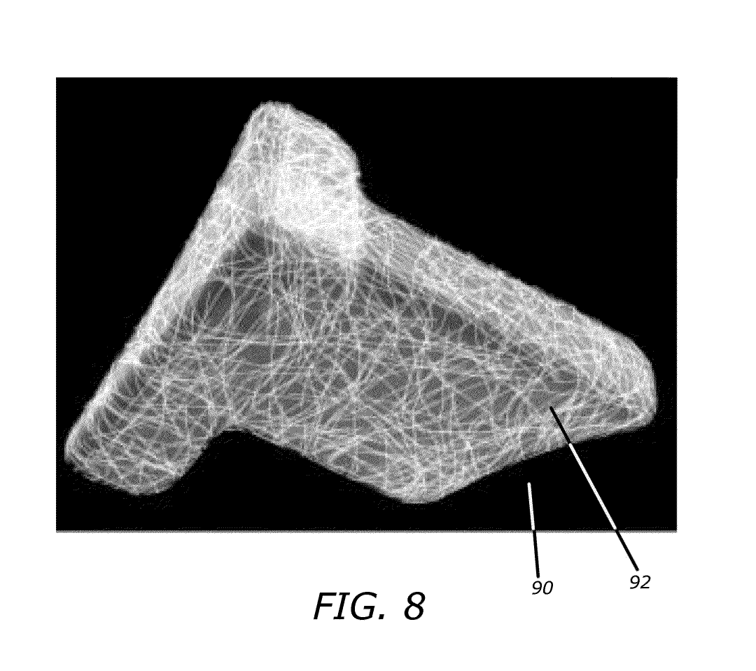

An X-ray image of a clip 80, which includes tracer chips 32 in accordance with the present invention, is shown at 90 in FIG. 8. The glass tows 24, which were located in the various tracer chips 32, are visible as white lines 92. The X-ray image showing the glass yarns provides a measure of the global position of the tracer chip as well as an image of the localized distortion or curving of each glass tow located within the tracer chip.

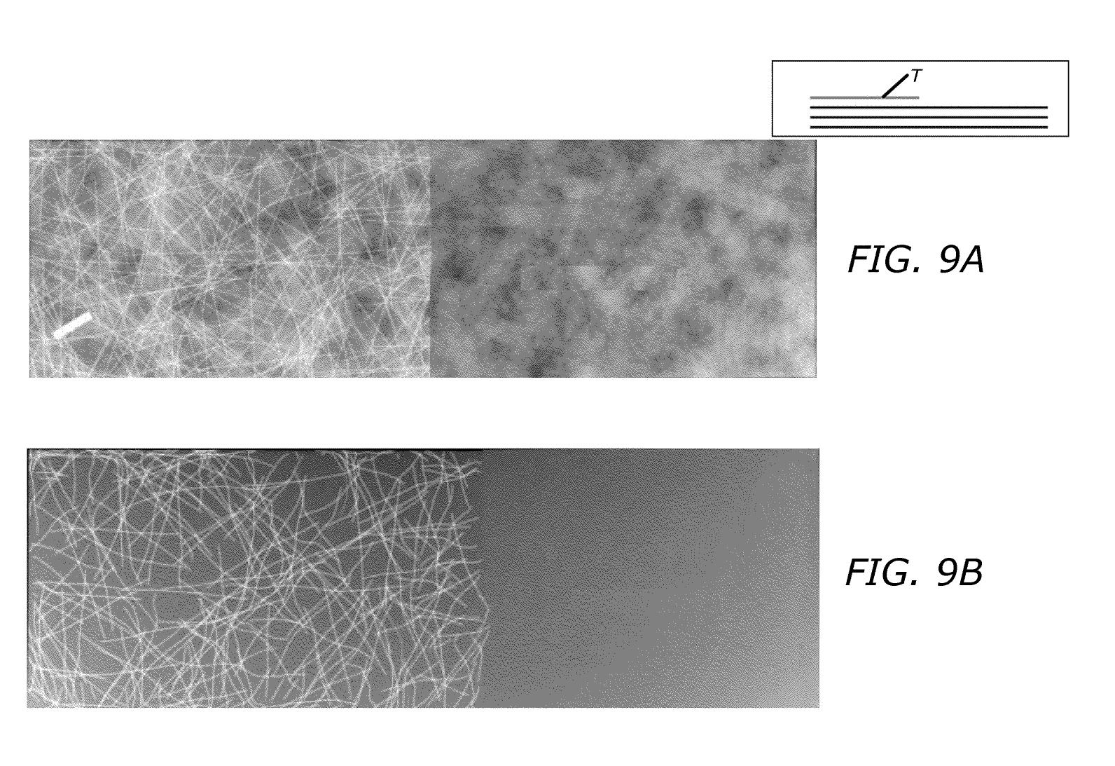

The present invention is particularly useful for monitoring the movement and intermingling of UD-DFC chips at the joints between pieces or layers of UD-DFC molding compound. For example, an X-ray image of a 4-layer UD-DFC laminate is shown in FIG. 9A prior to molding. The laminate configuration is schematically shown in the box located in the upper right hand corner of FIG. 9. The UD-DFC laminate includes 3 full layers of regular UD-DFC molding compound and a partial top layer (T) that contains tracer chips. The glass yarns in the tracer chips can be seen in the X-ray image as the white relatively straight segments that are each 50 mm long. The partial tracer layer T forms a drop off on top of the laminate configuration where the tracer layer ends only part way across the top of the laminate. FIG. 9B is an X-ray image of the 4-layer laminate after high pressure molding. As can be seen, some of the glass tracer yarns have moved globally across the drop off line during molding and the yarns have been distorted from their initial linear shape. This ability to monitor global movement and local distortion of the tracer chips at the drop off joint is a particular advantage provided by the tracer chip configuration of the present invention.

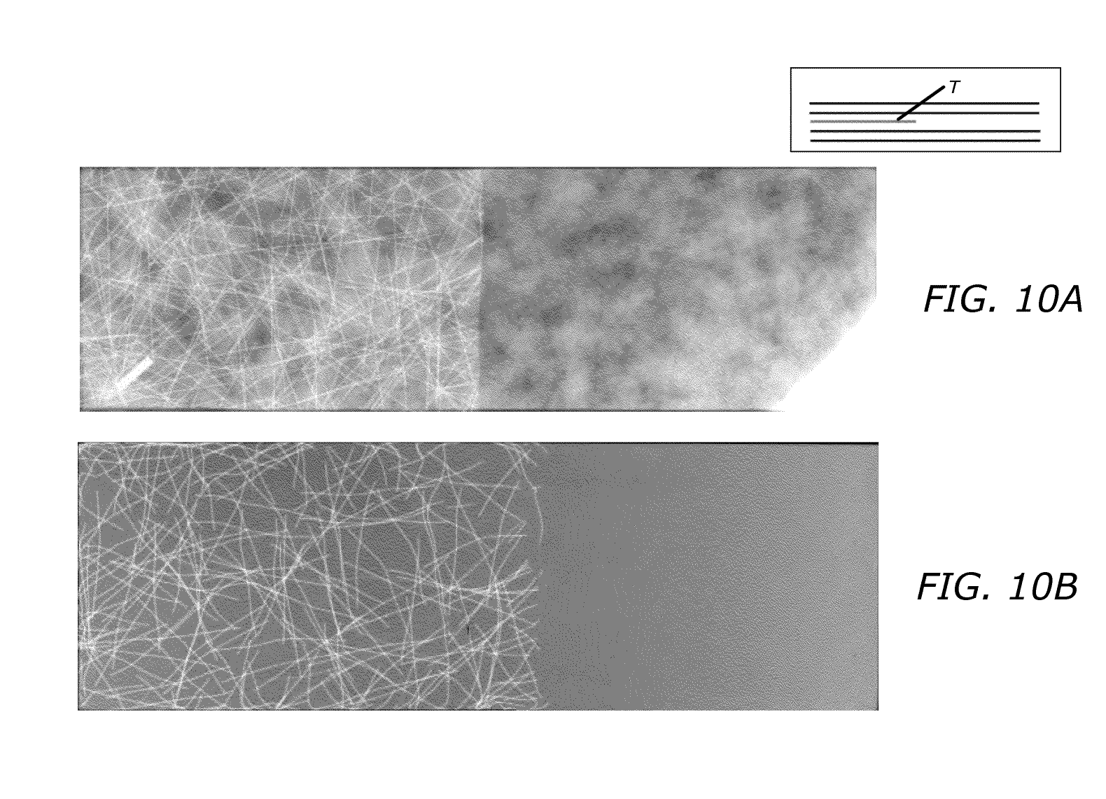

FIG. 10A is an exemplary X-ray image of a 5-layer UD-DFC laminate prior to molding. The laminate configuration is schematically shown in the box located in the upper right hand corner of FIG. 10. The UD-DFC laminate includes 4 full layers of regular UD-DFC molding compound and a partial middle layer (T) that contains tracer chips. The glass yarns in the tracer chips can be seen in the X-ray image as the white relatively straight segments that are each 50 mm long. The tracer layer T forms a drop off in the middle of the laminate configuration where the tracer layer ends only part way across the middle of the laminate. FIG. 10B is an X-ray image of the 4-layer laminate after high pressure molding. As can be seen, some of the glass tracer yarns have moved globally across the drop off line during molding and the yarns have been distorted from their initial linear shape.

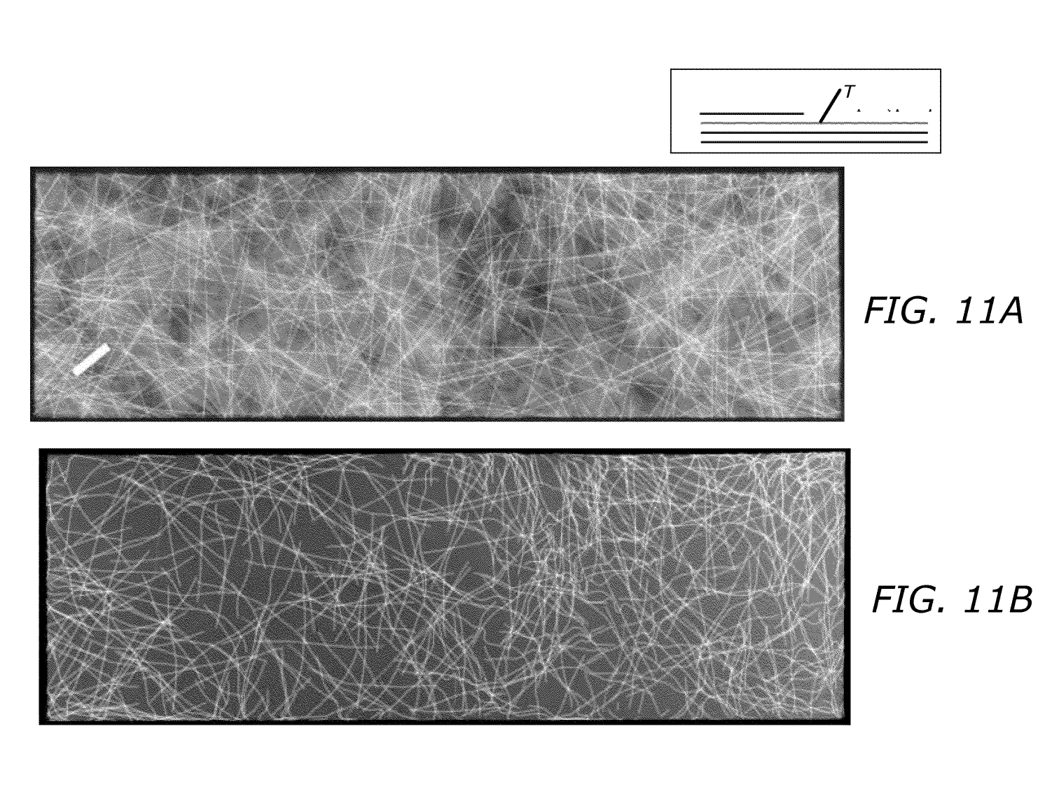

FIG. 11A is an exemplary X-ray image of a 4-layer UD-DFC laminate prior to molding. The laminate configuration is schematically shown in the box located in the upper right hand corner of FIG. 11. The UD-DFC laminate includes 2 full layers of regular UD-DFC molding compound and a full layer (T) that contains tracer chips, which is located on top of the UD-DFC molding compound layers. A partial layer of regular UD-DFC molding compound is located on top of the tracer layer T. The glass yarns in the tracer chips can be seen in the X-ray image as the white relatively straight segments that are each 50 mm long. FIG. 11B is an X-ray image of the 4-layer laminate after high pressure molding.

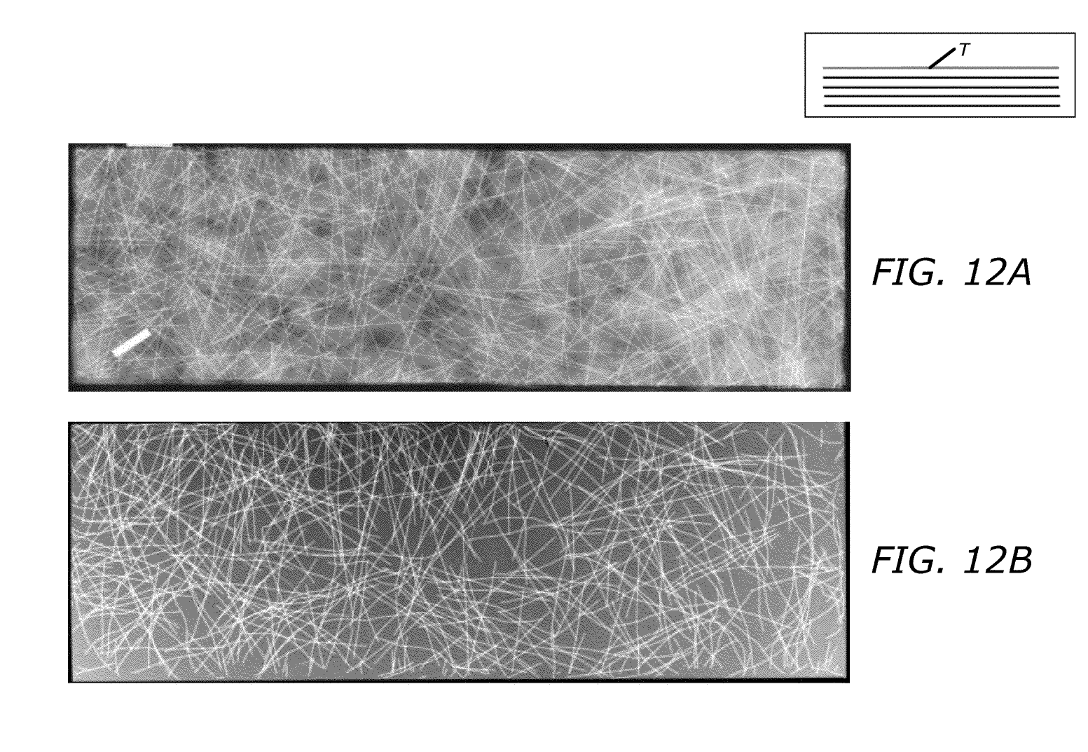

FIG. 12A is an exemplary X-ray image of a 5-layer UD-DFC laminate prior to molding. The laminate configuration is schematically shown in the box located in the upper right hand corner of FIG. 12. The UD-DFC laminate includes 4 full layers of regular UD-DFC molding compound and a full layer (T) that contains tracer chips, which is located on top of the UD-DFC molding compound layers. The glass yarns in the tracer chips can be seen in the X-ray image as the white relatively straight segments that are each 50 mm long. FIG. 12B is an X-ray image of the 5-layer laminate after high pressure molding.

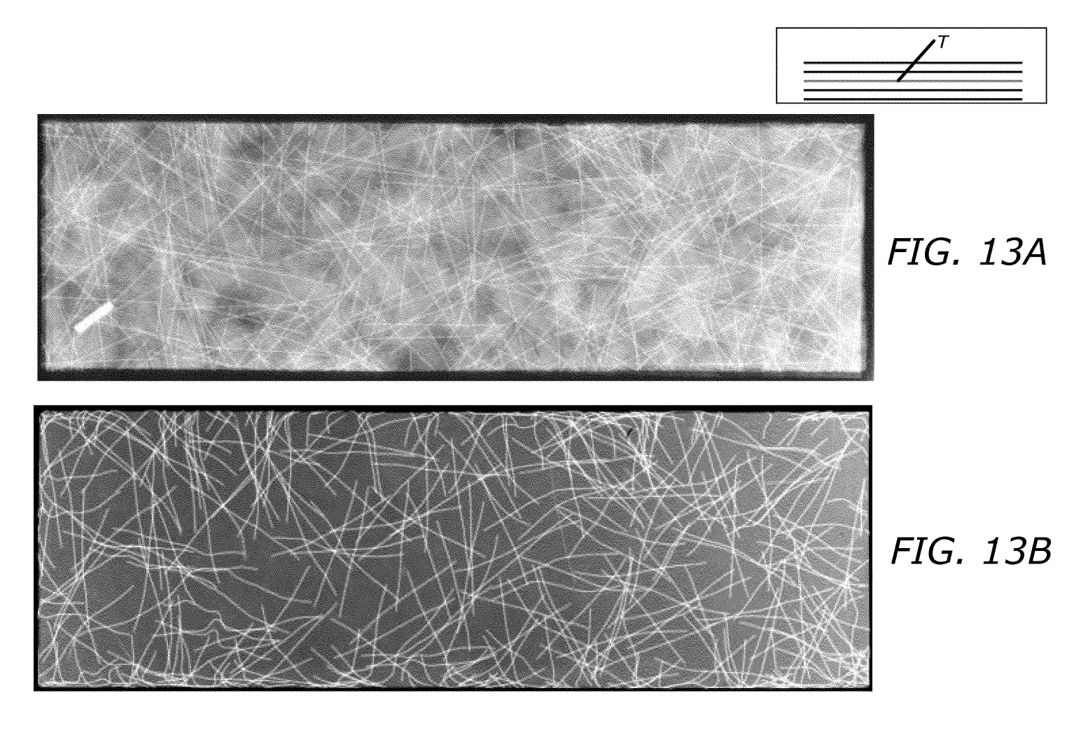

FIG. 13A is an exemplary X-ray image of a 5-layer UD-DFC laminate prior to molding. The laminate configuration is schematically shown in the box located in the upper right hand corner of FIG. 13. The UD-DFC laminate includes 4 full layers of regular UD-DFC molding compound and a full layer (T) that contains tracer chips, which is located in the middle of the UD-DFC molding compound layers. The glass yarns in the tracer chips can be seen in the X-ray image as the white relatively straight segments that are each 50 mm long. FIG. 13B is an X-ray image of the 5-layer laminate after high pressure molding.

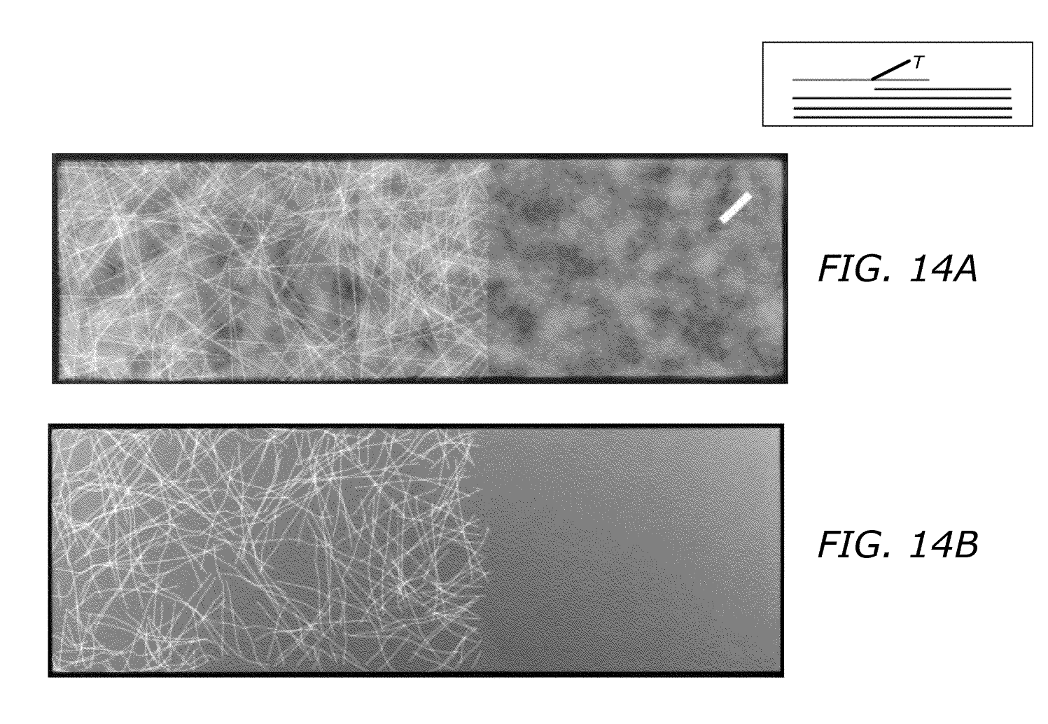

FIG. 14A is an exemplary X-ray image of a 5-layer UD-DFC laminate prior to molding. The laminate configuration is schematically shown in the box located in the upper right hand corner of FIG. 14. The UD-DFC laminate includes 3 fill layers of regular UD-DFC molding compound and a partial layer of regular UD-DFC molding compound located on top of the 3 full layers. A partial layer (T) that contains tracer chips is located on top of the laminate so that it overlaps the partial regular UD-DFC molding compound layer by 5 cm. The glass yarns in the tracer chips can be seen in the X-ray image as the white relatively straight segments that are each 50 mm long. FIG. 14B is an X-ray image of the 5-layer laminate after high pressure molding. As can be seen in this case, some of the glass tracer yarns have only slightly moved globally across the overlap line during molding and the yarns have been distorted from their initial linear shape.

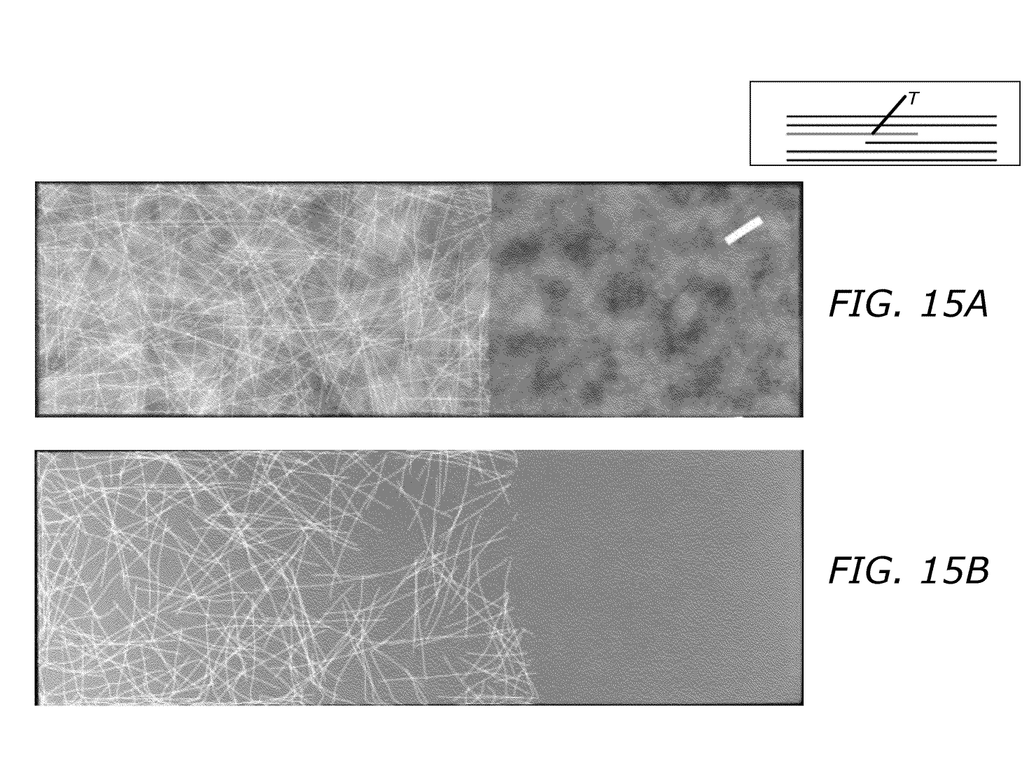

FIG. 15A is an exemplary X-ray image of a 6-layer UD-DFC laminate prior to molding. The laminate configuration is schematically shown in the box located in the upper right hand corner of FIG. 14. The UD-DFC laminate includes 4 full layers of regular UD-DFC molding compound and a partial layer of regular UD-DFC molding compound located in the middle of the laminate on top of a partial layer (T) that contains tracer chips. The partial tracer layer and regular layer are located so that they overlap each other by 5 cm. The glass yarns in the tracer chips can be seen in the X-ray image as the white relatively straight segments that are each 50 mm long. FIG. 15B is an X-ray image of the 6-layer laminate after high pressure molding. As can be seen, in contrast to FIG. 14 where the overlap is on the surface, some of the glass tracer yarns have moved globally across the overlap line during molding and the yarns have been distorted from their initial linear shape.

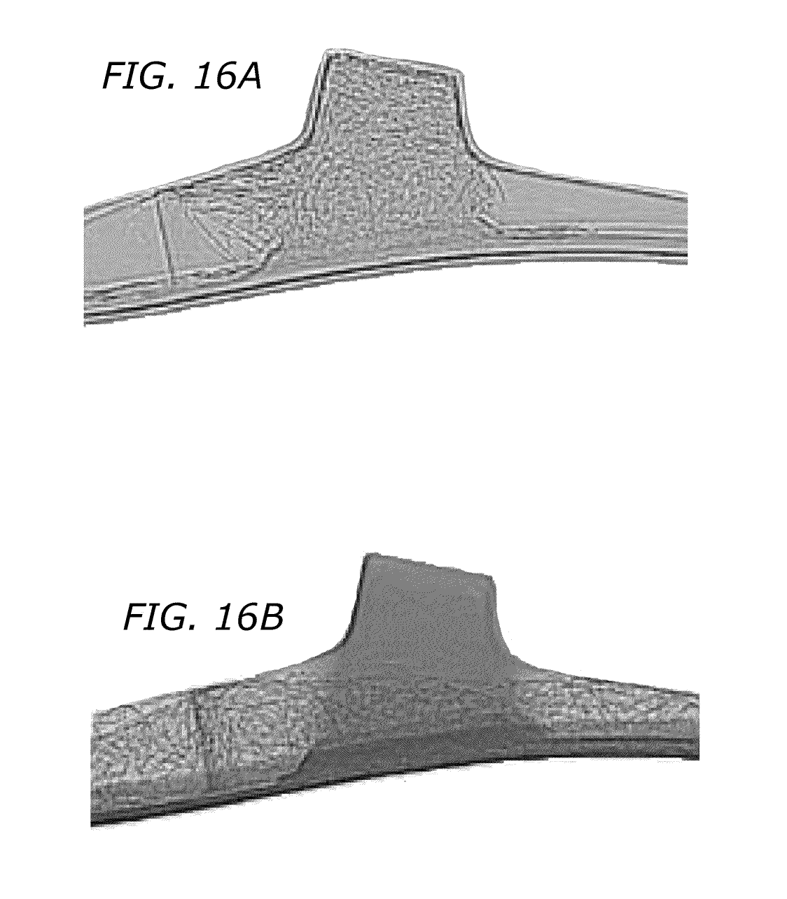

FIG. 16A and FIG. 16B shows X-ray images of a composite part that has been molded from a preform that includes a top piece of UD-DFC molding compound and a bottom piece of UD-DFC molding compound. In FIG. 16A, only the top piece of UD-DFC molding compound includes tracer chips. In FIG. 16B, only the bottom piece of UD-DFC molding compound includes tracer chips. The glass tracer yarns in the tracer chips show up in the X-ray images as black curved line segments. It is preferred that X-ray images be obtained with only one of the pieces containing tracer chips in order to make it possible to see movement of the tracers at the joint between the pieces. When both pieces contain tracer chips, it is difficult to determine movement of the tracers along the joint between the pieces. The two X-ray images 16A and 16B can be compared and/or superimposed over each other to provide an accurate indication of chip movement across the joint between the two pieces of UD-DFC molding compound and the final location and orientation of the chips. The two images in FIG. 16, when viewed together, show good movement and intermingling of the top and bottom pieces of UD-DFC molding compound.

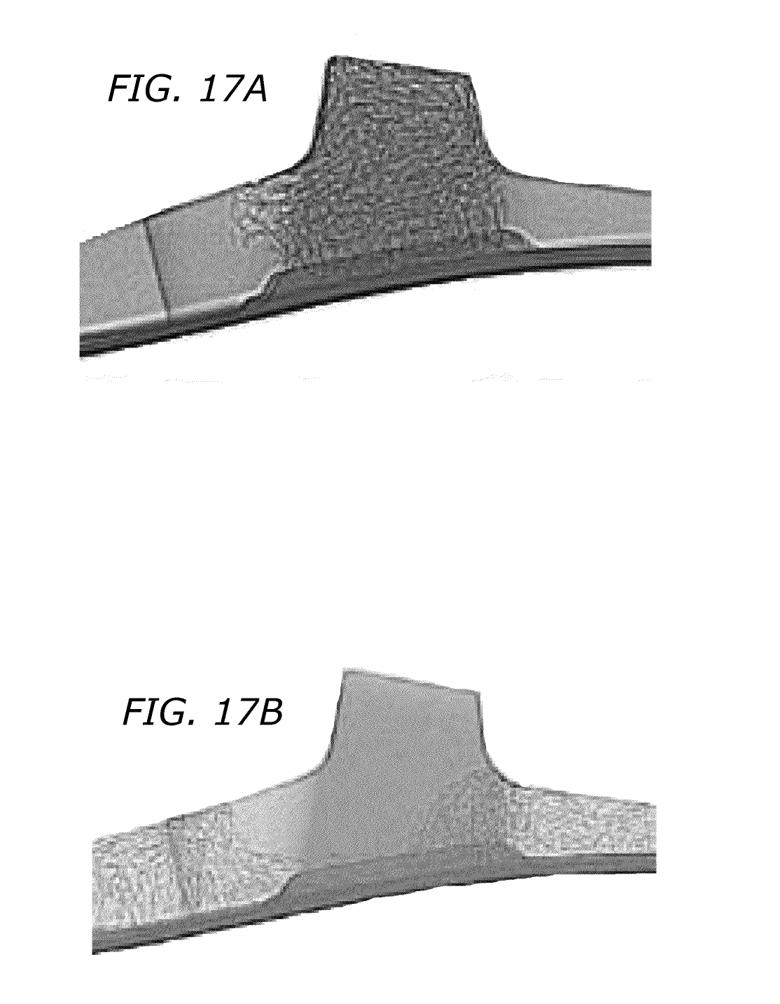

FIG. 17A and FIG. 17B are X-ray images of the same composite part as shown in FIG. 16, except that different top and bottom pieces of UD-DFC molding compound were used. The two images in FIG. 17, when viewed together, show poor movement and intermingling of the top and bottom pieces of UD-DFC molding compound.

The tracer chips are also particularly useful in monitoring UD-DFC chip location and movement along fold lines, such as fold lines 64 and 66 in the clip preliminary preform 60 in FIG. 5. For example, tracer chips located along the fold lines 64 and 66 are X-ray imaged in the flat preliminary preform 60. The curves formed by fold lines 64 and 66 are also X-ray imaged in the preform 70 and molded clip 80. Comparison of the X-ray images allows one to monitor and measure the global movement of the tracer chips as well as the localized distortion of the chips during formation of the preliminary preform 60 into the molded clip 80. In addition, X-ray imaging at the fold lines may be carried out at any one of the three stages during production of the clip for the purpose of simply measuring the location and distortion of the tracer chips. This measuring process does not necessarily include the step of monitoring movement of the tracer chips.

The tracer chips are also useful in monitoring UD-DFC chip location and movement in sections of the preform where there are overlapping portions of UD-DFC molding compound. For example the tabs of UD-DFC molding compound located on either side of the slot 62 in preliminary preform 60 are overlapped when the preliminary preform 60 is folded to form the preform 70. The sections of preform 70 containing overlapped UD-DFC molding compound will include twice as many tracer chips as the other non-overlapped section. Accordingly, it may be necessary to reduce the number of tracer chips in the overlapped sections in order to prevent overloading of the X-ray image.

As described above, the amount of tracer chips in the UD-DFC molding compound can be varied and controlled simply and accurately by varying the number of tracer chips in the single layer of tracer chips, as well as by varying the number of tracer chip layers that are included in the UD-DFC molding compound. This ability to accurately control and vary tracer chip concentration in the UD-DFC molding compound is particularly useful in situations where formation of the preform involves overlapping portions of the UD-DFC molding compound.

HexPly® AS4/8552 UD fiber prepreg is a commercially available UD prepreg (Hexcel Corporation, Dublin Calif.) that has been used to make the chips that are randomly oriented to form a single coplanar layer of quasi-isotropic chips. HexPly® AS4/8552 prepreg is a carbon fiber (AS4)/epoxy (8552) unidirectional tape that is 40 cm wide, 0.016 cm thick and has a fiber areal weight of about 145 grams/square meter. The carbon tows that are used to make this UD tape are AS4 carbon fiber that have 3K, 6K, 12K or 24K filaments. The resin content of the tape is 38 weight percent with the resin (8552) being a thermoplastic-toughened epoxy. The tape is slit to provide 8 mm strips and chopped to provide AS4-regular chips that are 50 mm long. The chip density is about 1.52 gram/cubic centimeter.

Exemplary AS4-tracer chips are preferably made in the same manner as above AS4-regular chips, except that when making the HexPly® AS4/8552 UD tape, a tow of glass fiber filaments having a matching cross-sectional size is substituted every 8 mm for an AS4 carbon tow. Slitting of the glass-tow modified UD tape every 8 mm and chopping at 50 mm intervals produces tracer chips that each include a single glass fiber tow. Other exemplary tracer chips can be made in the same manner by substituting glass fiber tows into other carbon fiber UD prepreg such as HexPly® UD tap prepreg AS4/IM7 (epoxy/carbon fiber), IM7/8552 (thermoplastic-toughened epoxy/carbon fiber), 3501-6/T650 (epoxy/carbon fiber) and IM7/M21 (thermoplastic-toughened epoxy/carbon fiber).

An exemplary layer of UD-DFC tracer material, which as shown in FIG. 3 is made up of a single layer of coplanar chips, is formed by applying a sufficient number of AS4-tracer chips and regular AS4 chips to the surface of release paper or other support sheet so that the layer has a areal weight of between 400 gsm and 4000 gsm. The number of AS4-tracer chips should be from 50% to 100% of the combined total number of AS4-tracer and AS4-regular chips.

Four of the exemplary layers of UD-DFC tracer material are combined to form a 4-ply multiple layered UD-DFC tracer sheet. UD-DFC molding compound (56 in FIG. 4) is then formed by combining the 4-ply multiple layered UD-DFC tracer sheet with 4-ply multiple layer UD-DFC sheets that contain only AS4-regular chips. The resulting tracer UD-DFC molding compound is then used in the same manner as regular UD-DFC molding compound.

X-ray imaging of the tracer UD-DFC compound is accomplished both before and/or after compression molding using X-ray equipment and systems that are routinely used in the aerospace industry.

Having thus described exemplary embodiments of the present invention, it should be noted by those skilled in the art that the within disclosures are exemplary only and that various other alternatives, adaptations and modifications may be made within the scope of the present invention. Accordingly, the present invention is not limited by the above-described embodiments, but is only limited by the following claims.

What is claimed is:

1. A tracer chip for use in compression molding of unidirectional discontinuous fiber composite molding compound, said tracer chip comprising:
a unidirectional carbon tow which comprises a plurality of unidirectional carbon filaments;
a unidirectional tracer yarn which comprises a plurality of unidirectional detectable filaments, said unidirectional carbon tow being located adjacent to and parallel with said unidirectional tracer yarn; and
a resin matrix.

2. A tracer chip for use in compression molding of unidirectional discontinuous fiber composite molding compound according to claim 1 wherein said unidirectional tracer yarn comprises a plurality of glass filaments.

3. A tracer chip for use in compression molding of unidirectional discontinuous fiber composite molding compound according to claim 1 wherein only one unidirectional tracer yarn is located in said tracer chip.

4. A tracer chip for use in compression molding of unidirectional discontinuous fiber composite molding compound according to claim 1 wherein from 1 to 5 unidirectional carbon tows are located in said tracer chip.

5. A tracer chip for use in compression molding of unidirectional discontinuous fiber composite molding compound according to claim 1 wherein said tracer chip is in the form of a rectangular chip.

6. A tracer chip for use in compression molding of unidirectional discontinuous fiber molding compound according to claim 1 wherein said unidirectional detectable filaments are detectable by X-ray imaging.

7. A unidirectional discontinuous fiber composite molding compound comprising:
a plurality of tracer chips according to claim 1 wherein said tracer chips are in a coplanar arrangement so that said unidirectional discontinuous fiber composite molding compound is in the form of a tracer layer comprising said tracer chips.

8. A unidirectional discontinuous fiber composite molding compound according to claim 7 wherein said tracer layer also comprises a plurality of carbon fiber chips which comprise unidirectional carbon tows that comprise a plurality of carbon fibers.

9. A unidirectional discontinuous fiber composite molding compound according to claim 7 wherein said unidirectional tracer yarn comprises a plurality of glass filaments.

10. A unidirectional discontinuous fiber composite molding compound according to claim 7 wherein only one unidirectional tracer yarn is located in said tracer chip.

11. A unidirectional discontinuous fiber composite molding compound according to claim 7 wherein from 1 to 5 unidirectional carbon tows are located in said tracer chip.

12. A unidirectional discontinuous fiber composite molding compound according to claim 7 wherein said tracer chip is in the form of a rectangular chip.

13. A unidirectional discontinuous fiber composite molding compound according to claim 7 wherein said unidirectional detectable filaments are detectable by X-ray imaging.

14. A unidirectional discontinuous fiber composite molding compound comprising a plurality of layers of carbon fiber chips and at least one tracer layer in accordance with claim 7.

15. A method for imaging molding joints in unidirectional discontinuous fiber composite molding compound, said method comprising the steps of:
providing a first portion of unidirectional discontinuous fiber composite molding compound that comprises a first surface, said first portion of unidirectional discontinuous fiber composite molding compound comprising a plurality of tracer chips according to claim 1 located along said first surface;
providing a second portion of unidirectional discontinuous fiber composite molding compound that comprises a second surface;
placing the first surface of said first portion against the second surface of said second portion to form a moldable joint between said first portion and said second portion;
molding said first portion to said second portion at said moldable joint to provide a molded joint between said first and second portions; and
imaging said unidirectional tracer yarn in said first portion before and/or after the molding step.

16. A method for imaging molding joints between two portions of unidirectional discontinuous fiber composite molding compound according to claim 15 wherein said second portion of unidirectional discontinuous fiber composite molding compound does not contain any tracer chips according to claim 1.

17. A method for imaging unidirectional discontinuous fiber composite molding compound during molding thereof, said method comprising the steps of:
providing a unidirectional discontinuous fiber composite molding compound which comprises a plurality of tracer chips according to claim 1;
molding said unidirectional discontinuous fiber composite molding compound to form a molded part; and
imaging said unidirectional tracer yarn in said unidirectional fiber composite molding compound before and/or after the molding step.

18. A method for imaging unidirectional discontinuous fiber composite molding compound according to claim 15 wherein the imaging step is accomplished using X-ray imaging.

19. A method for imaging unidirectional discontinuous fiber composite molding compound according to claim 17 wherein the imaging step is accomplished using X-ray imaging.

20. A composite part comprising a unidirectional discontinuous fiber composite molding compound according to claim 14 which has been cured.
